(19) United States
(12) Patent Application Publication
(10) Pub. No.: US 2012/0088061 A1
(43) Pub. Date: Apr. 12, 2012

(54) LAMINATE MATERIAL ELEMENT FOR A HOOK-AND-LOOP CLOSURE

(75) Inventors: Dieter HOMOELLE, Ochtrup (DE); Georg BALDAUF, Laer (DE)

(73) Assignee: NORDENIA DEUTSCHLAND GRONAU GMBH, Gronau (DE)

(21) Appl. No.: 13/269,070

(22) Filed: Oct. 7, 2011

(30) Foreign Application Priority Data
Oct. 8, 2010 (EP) 10 187 056.6

(51) Int. Cl. B32B 3/06

(52) U.S. Cl. 428/100

(57) ABSTRACT

A laminate material element for a hook-and-loop closure has a carrier and a textile knitted fabric laminated onto the carrier, which fabric has warp strands that run in the knitting direction, as well as loops incorporated into them, suitable for making a connection with hook-and-loop hooks, whereby the carrier and the knitted fabric are not connected with one another over their full area. An adhesive forms a lattice pattern, with adhesive strips that intersect perpendicularly and cells that are free of adhesive, whereby the adhesive strips run parallel to the warp strands in the knitting direction or perpendicular to the warp strands, respectively. Multiple warp strands are provided between two adjacent adhesive strips that run in the knitting direction.

### CROSS REFERENCE TO RELATED APPLICATIONS

Applicants claim priority under 35 U.S.C. §119 of European Application No. 10 187 056.6 filed Oct. 8, 2010, the disclosure of which is incorporated by reference.

### BACKGROUND OF THE INVENTION

1. Field of the Invention

The invention relates to a laminate material element for a hook-and-loop closure, having a carrier and a textile knitted fabric laminated onto the carrier, which fabric has warp strands that run in the knitting direction, as well as loops incorporated into them, suitable for making a connection with hook-and-loop hooks, whereby the carrier and the knitted fabric are not connected with one another over their full area, whereby an adhesive forms a lattice pattern, with adhesive strips that intersect perpendicularly and cells that are free of adhesive, and whereby the one group of the adhesive strips runs in the knitting direction. The laminate material element forms the female part of a hook-and-loop closure and is particularly intended for use on diapers.

When used on diapers, the laminate material element is applied on the front waistband region of the diaper. A closure strip that is attached to the diaper on the side and has hook-and-loop hooks on its free end makes the hook-and-loop closure complete. Using the hook-and-loop closure, the result can be achieved that the diaper is held in the waist region of the person wearing the diaper. Hook-and-loop closures can be opened and closed multiple times, without the functionality of the closure suffering as a result. In contrast to adhesive closures, hook-and-loop closures are not sensitive to contact with skin creams or powder.

The textile knitted fabric produced as warp-knitted fabric usually consists of polymer threads, whereby monofilament and/or multifilament yarns can be used to form the knitted fabric; these yarns usually consist of polypropylene, polyester, polyamide, or other synthetics that can be processed by means of textile technology.

Various demands are made on a laminate material element for a hook-and-loop closure on a disposable product, for example baby diapers or comparable incontinence articles for adults.

Both the transverse and the longitudinal direction of the opening forces are important for anchoring of the hook in the hook-and-loop closure, because during use, forces in both directions or angles between them can occur in the closed hook-and-loop closure, which forces can lead to unintentional opening of the hook-and-loop closure.

The transverse direction corresponds to the preferred direction of opening for the consumer, while the longitudinal direction is oriented perpendicular to it.

The knitted fabric intended for making the connection with the hook-and-loop hooks is supposed to guarantee sufficient interlocking with hook-and-loop hooks of the related closure tape, on the one hand, and to have a low weight per surface area, on the other hand, so that the lowest possible production costs are achieved. In order to achieve a firm connection with hook-and-loop hooks, a sufficient number of freely movable loops and fibers is necessary, and their function is not allowed to be impaired by gluing of the carrier to the knitted fabric. At the same time, the knitted fabric must be configured in such a stable manner, and must be sufficiently connected to the carrier by means of the adhesive, that it is possible to avoid tear-off and tearing even in the case of multiple activation of the hook-and-loop closure.

2. The Prior Art

A laminate material element having the characteristics described initially is known from WO 2006/045118 A1, whereby the application of adhesive is represented in a lattice pattern with straight adhesive strips that intersect perpendicularly, as a possible option. In the case of such an embodiment, it is provided that the adhesive strips that run in the knitting direction, adjacent to one another, have the same distance from one another as two warp strands that lie next to one another. In the case of register-precise gluing, all the warp strands are incorporated into the adhesive, thereby causing these regions not to be available for interlocking. If the warp strands have an offset as compared with the adhesive strips that run in the knitting direction, all the warp strands are attached only to the adhesive strips that run in the transverse direction, so that the laminate strength is clearly reduced. The laminate strength, on the one hand, and the hook-and-loop effect, on the other hand, can clearly vary as a function of the production tolerances. The amount of adhesive must be selected in such a manner that even in the case of incorrect orientation, sufficient laminate strength is still ensured.

A laminate material element for hook-and-loop closures, having a carrier and a textile knitted fabric laminated onto the carrier, which has warp strands in the knitting direction, as well as loops incorporated into them, suitable for use with hook-and-loop hooks, whereby the carrier and the knitted fabric are not connected with one another over their full area, is known from EP 1 997 942 A1. According to the known embodiment, an imprinted carrier made of a nonwoven material is used, whereby the carrier and the cover layer are connected by means of adhesive, which is applied in a pattern with adhesive surfaces and surfaces free of adhesive.

Laminate material elements for a hook-and-loop closure are known from EP 1 579 779 B1 and EP 1 690 967 B1, in which elements a carrier film and a textile substrate laminated onto the carrier film are connected with one another not over their full area. Both a warp-knitted fabric and a nonwoven material can be provided as the textile substrate. For a connection with the carrier film, parallel strips that run in a wave-line shape or intersecting strips that run in a wave-line shape are proposed. Alternatively, a cell-shaped structure can be provided, in which either the regions provided with adhesive or the regions free of adhesive are configured in point shape.

According to EP 1 690 967 B1, proceeding from this, it is furthermore provided that the laminate material elements are provided with a circumferential adhesive frame, in order to avoid that the textile material is torn off the carrier film when increased tensile forces occur at the edge.

Even though the known laminate material elements have proven themselves in practice, there continues to be a need to improve the interlocking ability of the laminate material element. For example, in practice, unintentional opening of hook-and-loop closures has been observed, in part, if maximal anchoring of the hook in the loop part of the hook-and-loop closure cannot be achieved. In such a case, there is the risk that a sufficient number of connections between hook-and-loop hooks and loops of the knitted fabric will not be achieved.

### SUMMARY OF THE INVENTION

Against this background, the invention is based on the task of indicating a laminate material element for a hook-and-loop closure, having the characteristics stated initially, which closure can be cost-advantageously produced and in addition demonstrates increased interlocking ability in both force directions that occur, i.e. in the longitudinal and transverse direction, and in the angles between them.

This task is accomplished, according to the invention, in that multiple warp strands are provided between two adjacent adhesive strips that run in the knitting direction. Usually, it is provided that the adhesive strips, which intersect perpendicularly, run straight and therefore form a lattice pattern with rectangular adhesive-free cells. The warp strands that are disposed between two adjacent adhesive strips that run in the knitting direction are accordingly attached only to the adhesive strips that run perpendicular to the knitting direction.

According to the invention, the adhesive pattern is formed not only from adhesive strips that run perpendicular to one another, and are eventually straight, but also oriented in a predetermined arrangement with reference to the knitted fabric, so that the adhesive strips run parallel to the warp strands in the knitting direction, or perpendicular to the warp strands, respectively. Extensive gluing of the knitted fabric takes place at individual warp strands that are disposed in the region of the adhesive strips that run in the knitting direction, so that there, the ability of making a connection with the hook-and-loop hooks is reduced locally. Multiple, for example between two and ten warp strands are provided between two adjacent adhesive strips that run in the knitting direction, which strands are attached only on the adhesive strips that run perpendicular to the knitting direction, so that easier interlocking with hook-and-loop hooks is possible in the region of these warp strands. Not only can the hook-and-loop hooks easily engage into the free loops, in the regions free of adhesive, but also they can engage into the other threads of the knitted fabric. The best local interlocking effect can be expected in the adhesive-free cells, where the knitted fabric is not connected with the carrier and thus is freely movable.

Despite the locally increased ability of making a connection with hook-and-loop hooks, no undesirable, complete loosening of the knitted fabric from the carrier or tearing of the knitted fabric are observed, in the case of gluing according to the invention, by means of simple, straight strips that intersect at right angles, at a usual weight per surface area of the knitted fabric.

As was previously explained in the definition of the knitted fabric, multiple warp strands run between two adjacent adhesive strips that run in the knitting direction. Preferably, the distance measured from center to center of two adjacent adhesive strips that run in the knitting direction is between four times to ten times as great as the correspondingly determined distance between adjacent warp strands. In the case of a usual embodiment of the invention, the distance measured from center to center between adjacent adhesive of two strips that run in the knitting direction amounts to between 7 mm and 20 mm.

The width of the adhesive-free cells is less, corresponding to the width of the adhesive strips, whereby the proportion of surface provided with adhesive usually lies between 10% and 50%, preferably between 20% and 30%, in the region disposed within the frame. In connection with the proportion of the surface to be provided with adhesive, it must be taken into consideration that in the case of a great value, not only does the ability to enter into a connection with hook-and-loop hooks decrease, but also the costs increase due to the increased application of adhesive. In general, the glued surfaces have a clearly reduced interlocking ability, because the threads of the knitted fabric that are needed for functioning are completely fixed in place by the adhesive and are available for interlocking only to an insufficient degree. In contrast, if the proportion of the area provided with adhesive is too small, there is the risk that the knitted fabric can be torn off from the carrier or can tear due to a non-uniform distribution of force.

The adhesive-free cells preferably follow a square or rectangular geometry. Even if no square configuration of the adhesive-free cells is provided, the distance between adjacent adhesive strips that run in the transverse direction preferably lies in the stated range of 7 mm to 20 mm, particularly between 7 mm and 15 mm.

The distance between adjacent warp strands is clearly lower, and typically lies between 1 mm and 3 mm, preferably between 1.2 mm and 2.2 mm. In the knitted fabric, connection threads preferably run in a zigzag over two adjacent or multiple warp strands, in the knitting direction. In the selection of the knitted fabric, it must be taken into consideration that when the weight per surface area is increased, more loops can be made available, which allow a connection with hook-and-loop hooks. In contrast, the material costs are decreased with a reduction in the weight per surface area. In addition, the knitted fabric should also be as translucent as possible, so that a decorative imprint disposed underneath it can be perceived well. Against this background, the weight per surface area of the knitted fabric generally lies between 8 g/m² and 40 g/m², preferably at less than 21 g/m², particularly preferably between preferably 10 g/m² and 18 g/m².

The width of the adhesive strips that run in the knitting direction, as well as of those that run perpendicular to them, typically lies between 0.5 mm and 5 mm, preferably between 0.5 mm and 1.5 mm. It must be taken into consideration that the adhesive strips are always supposed to incorporate at least one warp strand, and for this reason, it is practical if the adhesive strips that run in the knitting direction, in particular, have a width of at least 0.4 mm. The adhesive strips are preferably continuous. However, a configuration that deviates from this, with interrupted adhesive lines, is not excluded. Also, adhesive strips that consist of a dotted line or also of interrupted, straight line segments, for example, are possible.

A film that preferably has a weight per surface area between 5 g/m² and 50 g/m² can be provided as a carrier. Mono-films as well as films co-extruded or laminated in multiple layers can be used. Films made of polyethylene, polypropylene, polyester, polyamide, as well as mixtures from copolymerization on the basis of these polymers, for example, are suitable. Preferably, carrier films that are cost-advantageous and whose surface can be imprinted using recto printing are used. Alternatively, a nonwoven fabric can also be provided as a carrier; this can be configured in accordance with EP 1 997 942 A1.

As is known from EP 1 690 967 B1, it can be provided that the carrier and the knitted fabric are glued ₜo one another over their full area in an edge region that extends along the edges of the laminate material element and has the shape of a frame, thereby avoiding tearing off of the knitted fabric from the carrier in this edge region. Depending on the shape and size of the laminate material element chosen, in each instance, the frame usually has a width between usually 4 mm and 10 mm.

In the simplest case, the laminate material element has an approximately rectangular, oblong cut, thereby allowing the hook tape of a hook-and-loop closure to be placed at different positions, in order to adapt to a different waist circumference. Fundamentally, however, other geometric shapes of the laminate material element can also be implemented, by means of a corresponding cut.

### BRIEF DESCRIPTION OF THE DRAWINGS

In the following, the invention will be explained using a drawing that shows only an exemplary embodiment. This schematically shows:

FIG. 1A a top view of a laminate material element according to the invention,

FIG. 1B a schematic view of a partial region of a glued knitted fabric,

FIGS. 2A and 2B alternative embodiments of an adhesive pattern according to the state of the art,

FIG. 2C a schematic view of an adhesive pattern according to the invention,

FIGS. 3A and 3B for two different hook-and-loop hook types, the maximal required force to open a hook-and-loop closure along the knitting direction (peel in longitudinal direction), for different adhesive patterns and different knitted fabrics with different weights per surface area,

FIGS. 4A and 4B for the two different hook-and-loop hook types, the maximal required force to open a hook-and-loop closure in the transverse direction (peel in transverse direction), for different adhesive patterns and different knitted fabrics with different weights per surface area.

### DETAILED DESCRIPTION OF PREFERRED EMBODIMENTS

The required opening forces in the transverse direction and the longitudinal direction took place according to ASTM method D 5170-98 (Reapproved 2004) with the title Standard Test Method for Peel Strength (“T” Method) of Hook and Loop Touch Fasteners, however with the following deviations from this standard: The width of the hook element is 25.4 mm and the length is 13 mm. The length of 13 mm results from the fact that a roll with a hook material having a corresponding width is used, from which the individual sections are cut. The hook sections were glued onto a paper strip having a weight per surface area of 90 g/m², which has a width of 25.4 mm and a length of 210 mm. The hook elements were glued onto the center of the paper strip in such a manner that the width of the hook element agrees with the width of the paper strip. The laminate material element that forms the female part of the hook-and-loop closure was made available at a width of 25.4 mm and a length of 100 mm. In order to determine the opening forces (peel force) in the transverse direction, an orientation was selected at which the knitting direction (W) of the textile knitted fabric 2 corresponds to the width of the laminate material element. In order to determine the peel force in the longitudinal direction, the pattern was formed in such a manner that the knitting direction (W) of the textile knitted fabric (2) corresponds to the length of the laminate material element.

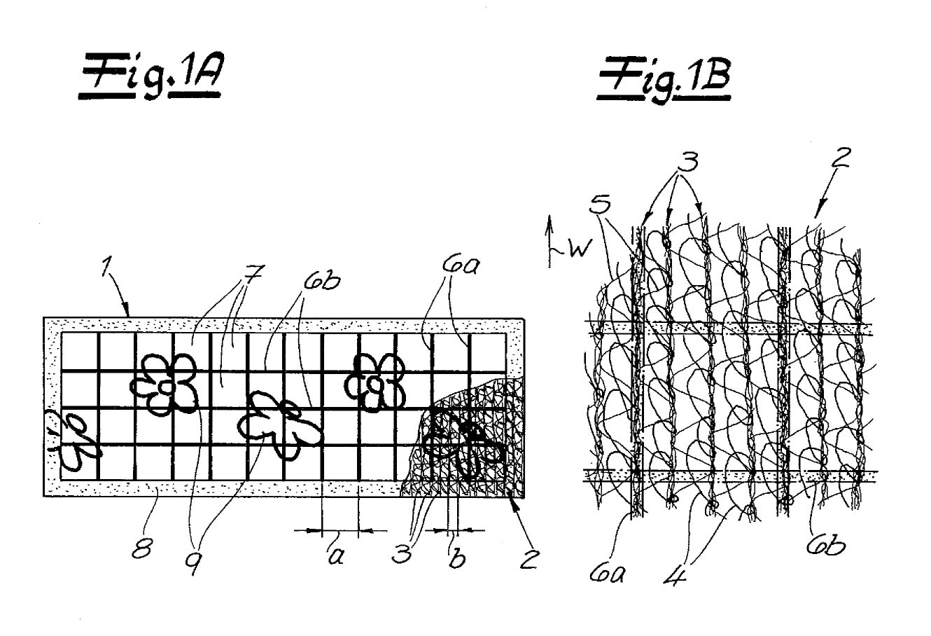

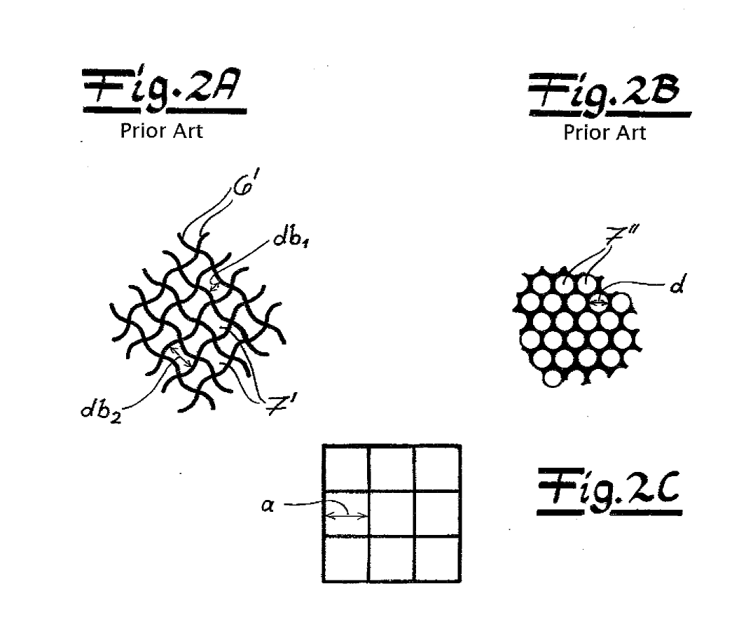

FIG. 1A and FIG. 1B show a laminate material element that forms the female part of a hook-and-loop closure and is affixed to the front region of a diaper when used as a diaper closure. The laminate material element consists of a film as a carrier 1 and a textile knitted fabric 2 laminated onto the carrier 1 as a cover layer. The knitted fabric 2 is formed from polymer threads, as a warp-knitted fabric, and comprises warp strands 3 that run in the knitting direction, as well as loops 4 that are incorporated into them and are suitable for making a connection with hook-and-loop hooks, whereby warp strands 3 that are parallel to one another are connected by means of connection threads 5 that run in zigzag manner.

The textile knitted fabric 2 is connected with the carrier 1 by means of an adhesive pattern, whereby the adhesive forms a lattice pattern with straight adhesive strips 6a, 6b that intersect perpendicularly, and rectangular or square adhesive-free cells 7, in a central region of the laminate material element. A first part of the adhesive strips 6a runs parallel to the warp strands 3 in the knitting direction W, whereby the other adhesive strips 6b accordingly run perpendicular to the warp strands 3. While individual warp strands 3 are completely held in the adhesive in the region of the adhesive strips 6a that run in the knitting direction W, additional warp strands 3 are provided between the adhesive strips 6a that run in the knitting direction W, which strands are held only on the adhesive strips 6b that run in the transverse direction. While good interlocking with hook-and-loop hooks is possible in the region of these adhesive strands 3, within the adhesive-free cells 7, the knitted fabric 2 is securely attached in the region of the adhesive strips 6a that run in the knitting direction W, whereby in order to guarantee a secure hold, it is advantageous if entire warp strands 3 are incorporated into the adhesive. In order to avoid that the knitted fabric 2 is torn off from the carrier 1, a closed, circumferential frame 8 is possible at the edge of the laminate material element, which frame has a width between 4 mm and 10 mm. In this connection, the laminate material element can be formed by means of a corresponding application of adhesive to a larger material web, with repeat, and then by cutting out a laminate material element.

Within the circumferential frame 8 formed of adhesive, the proportion of the surface provided with adhesive amounts to between 20% and 30%, thereby making it possible to achieve a good connection with hook-and-loop hooks in the adhesive-free cells 7, on the one hand, and a sufficient connection of the knitted fabric 2 with the carrier 1, on the other hand.

The distance a between adjacent adhesive strips 6a, 6b, in each instance, usually amounts to between 7 mm and 15 mm, whereby the distance b between adjacent warp strands 3, at 1 mm to 3 mm, is clearly lower. In the exemplary embodiment shown, the distance a, determined from center to center, between adjacent adhesive strips 6a, 6b, amounts to approximately 10 mm, and the distance b between adjacent warp strands 3 amounts to about 1.7 mm.

As indicated in FIG. 1, the carrier 1 is usually provided with a decorative imprint 9 that is visible through the translucent knitted fabric 2. The weight per surface area of the knitted fabric 2 usually amounts to between 15 g/m² and 40 g/m², preferably between 18 g/m² and 28 g/m².

In order to determine the hook-and-loop effect of the laminate material element according to the invention, the maximal forces to be applied for opening were determined for different adhesive patterns and knitted fabrics having different weights per surface area, in an experimental setup.

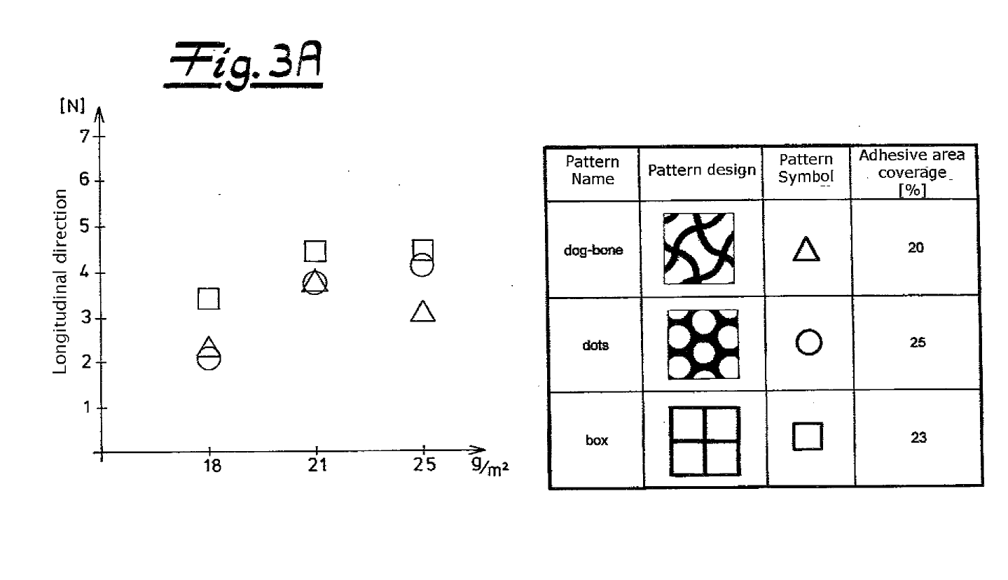

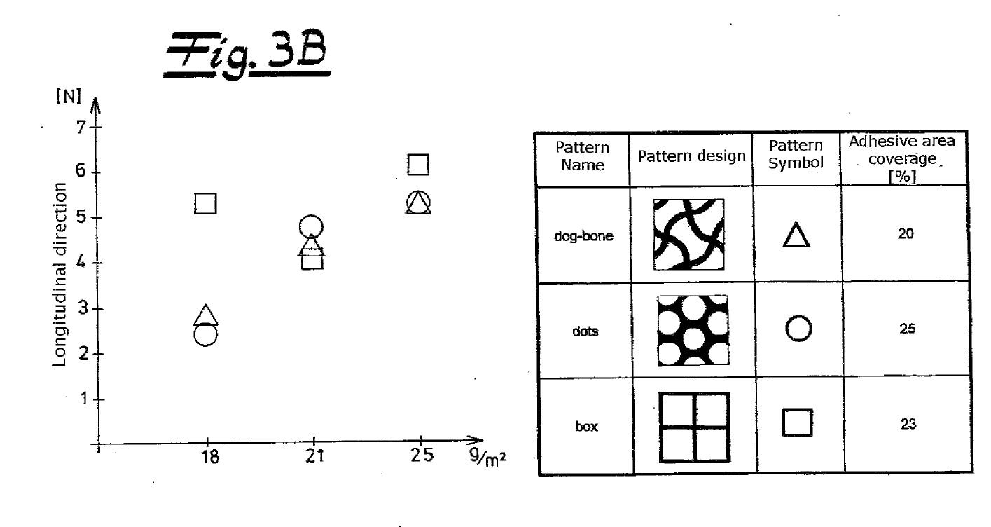

For this purpose, different regions of a carrier film 1 were provided with a square pattern according to the present invention, a pattern of intersecting wavy lines, as well as a pattern of dot-shaped adhesive-free regions. In the square pattern according to the present invention, the distance a between adjacent adhesive strips amounted to about 8.6 mm, and the proportion of the surface provided with adhesive amounted to 23% (FIG. 2C).

FIGS. 2A and 2B show the patterns used for comparison. The pattern shown in FIG. 2A, composed of intersecting adhesive strips 6′ that run in wave shape, is also referred to as a “dog bone” pattern, because of the adhesive-free cells 7′ that form. In the case of the “dog bone” pattern, the proportion of the surface provided with adhesive amounts to about 20% of the total surface area. The smallest distance between two adjacent wave-shaped adhesive strips db₁ amounts to 4.6 mm in the comparison pattern, and the greatest distance db₂ measured perpendicular to it amounts to 14.4 mm.

FIG. 2b shows a comparison pattern with dot-shaped adhesive-free cells 7″, whereby the proportion of the surface provided with adhesive amounts to about 25% of the total surface area. The diameter d of the adhesive-free cells 7″ amounts to 11.7 mm in the comparison pattern.

The carrier 1 was glued to textile knitted fabrics by means of the adhesive pattern according to the invention and the two comparison patterns; these fabrics differ by their weight of 18 g/m², 21 g/m², and 25 g/m², respectively.

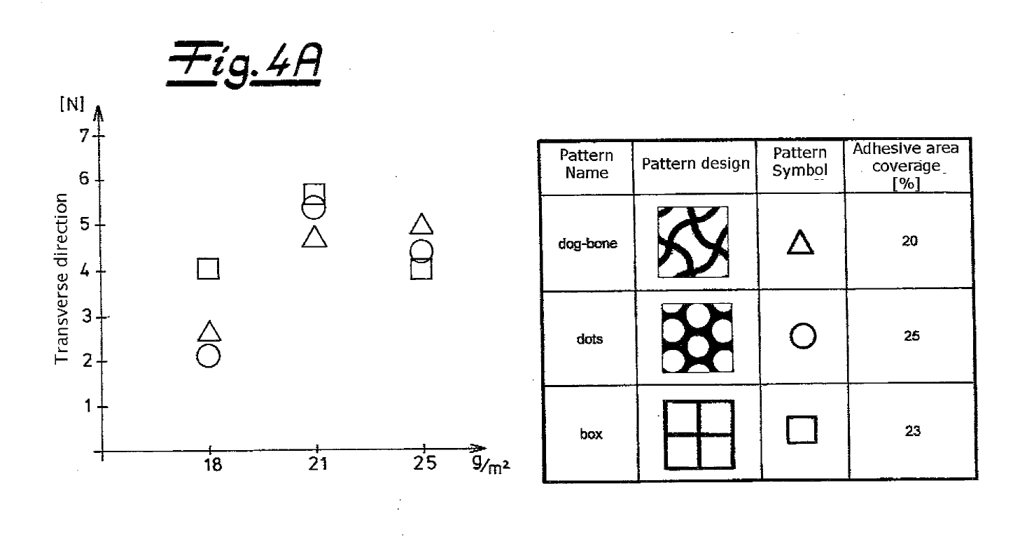

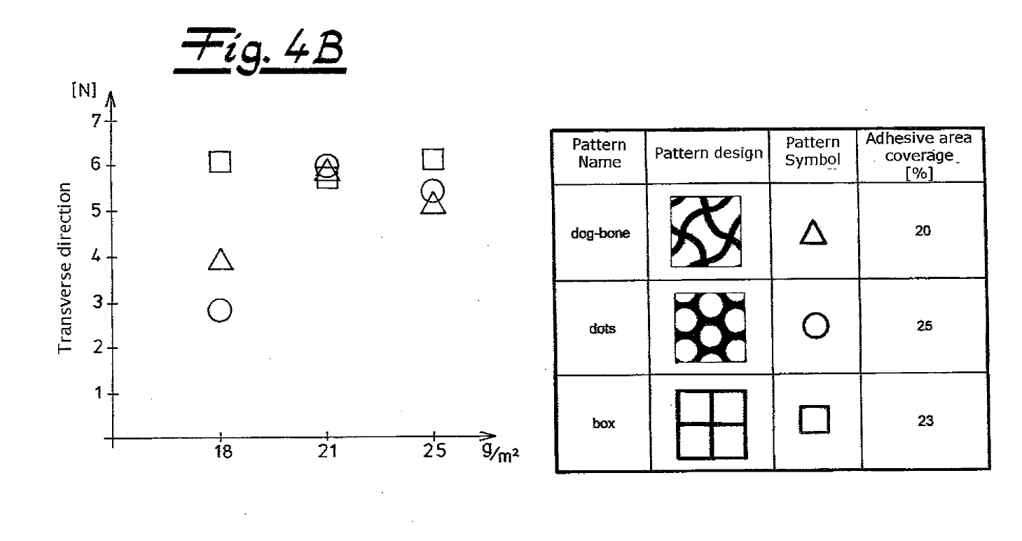

The measurements according to FIG. 3A and FIG. 4A took place with hook-and-loop hooks of the type Aplix 962. The measurements according to FIG. 3B and FIG. 4B took place with hook-and-loop hooks of the type 3M CHK 01088. A three-layer PE film having a weight per surface area of 17 g/m² was used as a carrier 1. Gluing together of carrier 1 and knitted fabric 2 took place with a single-component polyurethane adhesive. The measurement took place according to the method that is described under Point 8 of ASTM D 5170-98 (Reapproved 2004), however with the proviso that only the experimental configuration 1 according to FIG. 2 of ASTM D 5170-98 (Reapproved 2004) was measured. According to this standard, the average value of the peel force can be determined by means of integration. The corresponding results are compiled in Table 3 and 4. In connection with hook-and-loop closures, however, the maximal peel forces, specifically, are particularly informative, and for this reason, FIG. 3A and 3B and FIGS. 4A and 4B, respectively, indicate the maximal forces occurring during an opening movement in the longitudinal direction and the transverse direction, respectively. The corresponding values are also reproduced in Table 1 and Table 2.

In the case of the comparison measurements shown in FIG. 3A and 3B, the different weights per surface area are reproduced on the horizontal axis, whereby the vertical axis indicates the maximal force occurring during an opening movement in the longitudinal direction, in newtons.

In the case of the comparison measurements shown in FIGS. 4A and 4B, the different weights per surface area are reproduced on the horizontal axis, whereby the vertical axis indicates the maximal force occurring during an opening movement in the transverse direction, in newtons.

TABLE 1
Maximal peel force for hooks Aplix 962

| | 18 g knitted | | | 21 g knitted | | | 25 g knitted | | |
|---|---|---|---|---|---|---|---|---|---|
| | fabric | | | fabric | | | fabric | | |
| | | | dog | | | dog | | | dog |
| | dot | box | bone | dot | box | bone | dot | box | bone |
| Max. peel | 2.0 | 3.4 | 2.4 | 3.7 | 4.4 | 3.8 | 4.1 | 4.4 | 3.1 |
| force in the | | | | | | | | | |
| longitudinal | | | | | | | | | |
| direction | | | | | | | | | |
| [N/25.4 mm] | | | | | | | | | |
| Max. peel | 2.1 | 4.0 | 2.6 | 5.3 | 5.6 | 4.7 | 4.3 | 4.0 | 5.0 |
| force in the | | | | | | | | | |
| transverse | | | | | | | | | |
| direction | | | | | | | | | |
| [N/25.4 mm] | | | | | | | | | |

TABLE 2
Maximal peel force for hooks CHK 01088 from 3M

| | 18 g knitted | | | 21 g knitted | | | 25 g knitted | | |
|---|---|---|---|---|---|---|---|---|---|
| | fabric | | | fabric | | | fabric | | |
| | | | dog | | | dog | | | dog |
| | dot | box | bone | dot | box | bone | dot | box | bone |
| Max. peel | 2.4 | 5.3 | 2.8 | 4.7 | 4.0 | 4.3 | 5.2 | 6.1 | 5.2 |
| force in the | | | | | | | | | |
| longitudinal | | | | | | | | | |
| direction | | | | | | | | | |
| [N/25.4 mm] | | | | | | | | | |
| Max. peel | 2.8 | 7.0 | 3.9 | 6.0 | 5.7 | 5.9 | 5.4 | 6.1 | 5.2 |
| force in the | | | | | | | | | |
| transverse | | | | | | | | | |
| direction | | | | | | | | | |
| [N/25.4 mm] | | | | | | | | | |

TABLE 3
Integrated average value of the peel force for hooks
Aplix 962

| | 18 g knitted | | | 21 g knitted | | | 25 g knitted | | |
|---|---|---|---|---|---|---|---|---|---|
| | fabric | | | fabric | | | fabric | | |
| | | | dog | | | dog | | | dog |
| | dot | box | bone | dot | box | bone | dot | box | bone |
| Integrated | 0.7 | 0.9 | 0.5 | 0.9 | 1.2 | 0.8 | 1.0 | 1.1 | 1.1 |
| average | | | | | | | | | |
| value of the | | | | | | | | | |
| peel force | | | | | | | | | |
| in the | | | | | | | | | |
| longitudinal | | | | | | | | | |
| direction | | | | | | | | | |
| [N/25.4 mm] | | | | | | | | | |
| Integrated | 1.1 | 1.5 | 0.8 | 1.8 | 1.9 | 1.5 | 1.2 | 1.3 | 1.6 |
| average | | | | | | | | | |
| value of the | | | | | | | | | |
| peel force | | | | | | | | | |
| in the | | | | | | | | | |
| transverse | | | | | | | | | |
| direction | | | | | | | | | |
| [N/25.4 mm] | | | | | | | | | |

TABLE 4
Integrated average value of the peel force for hooks
CHK 01088 from 3M

| | 18 g knitted | | | 21 g knitted | | | 25 g knitted | | |
|---|---|---|---|---|---|---|---|---|---|
| | fabric | | | fabric | | | fabric | | |
| | | | dog | | | dog | | | dog |
| | dot | box | bone | dot | box | bone | dot | box | bone |
| Integrated | 0.6 | 1.5 | 0.9 | 1.3 | 0.9 | 1.3 | 1.1 | 1.2 | 1.8 |
| average | | | | | | | | | |
| value of the | | | | | | | | | |
| peel force | | | | | | | | | |
| in the | | | | | | | | | |
| longitudinal | | | | | | | | | |
| direction | | | | | | | | | |
| [N/25.4 mm] | | | | | | | | | |
| Integrated | 1.1 | 2.2 | 1.5 | 1.8 | 1.9 | 1.7 | 1.5 | 1.9 | 1.8 |
| average | | | | | | | | | |
| value of the | | | | | | | | | |
| peel force | | | | | | | | | |
| in the | | | | | | | | | |
| transverse | | | | | | | | | |
| direction | | | | | | | | | |
| [N/25.4 mm] | | | | | | | | | |

The values were recorded and averaged by way of a large number of measurements (n=10). The values for the adhesive pattern according to the invention are shown as squares, the values for the dot pattern as circles, and the values for the “dog bone” pattern as triangles. The values for the pattern according to the invention lie significantly above the comparison values with hook-and-loop hooks of the type Aplix 962, for the different textile knitted fabrics, particularly at weights per surface area of <21 g/m². This holds true for the opening forces measured both in the longitudinal and the transverse direction.

This leads, overall, to a significant improvement in the material properties of the hook-and-loop closure, because the resistance to opening the hook-and-loop closure has increased in all directions.

What is claimed is:

1. Laminate material element for a hook-and-loop closure, having a carrier (1) and a textile knitted fabric (2) laminated onto the carrier (1), which fabric has warp strands (3) that run in the knitting direction (W), as well as loops (4) incorporated into them, suitable for making a connection with hook-and-loop hooks, whereby the carrier (1) and the knitted fabric (2) are not connected with one another over their full area, whereby an adhesive forms a lattice pattern, with adhesive strips (6a, 6b) that intersect perpendicularly and cells (7) that are free of adhesive, and whereby the one group of the adhesive strips (6a) runs in the knitting direction (W), wherein multiple warp strands (3) are provided between two adjacent adhesive strips (6a) that run in the knitting direction (W).

2. Laminate material element according to claim 1, wherein the adhesive strips (6a, 6b), which intersect perpendicularly, run straight and therefore form a lattice pattern with rectangular adhesive-free cells (7), whereby the warp strands (3) that are disposed between two adjacent adhesive strips (6a) that run in the knitting direction (W) are attached only to the adhesive strips (6b) that run perpendicular to the knitting direction (W).

3. Laminate material element according to claim 1, wherein the distance (a) between adjacent adhesive strips (6a) that run in the knitting direction (W) amounts to between 7 mm and 20 mm.

4. Laminate material element according to claim 1, wherein the distance (b) between adjacent warp strands (3) lies between 1 mm and 3 mm, preferably between 1.2 mm and 2.2 mm.

5. Laminate material element according to claim 1, wherein the adhesive-free cells (7) are square.

6. Laminate material element according to claim 1, wherein the proportion of the surface area provided with adhesive lies between 20% and 30% in the central region.

7. Laminate material element according to claim 1, wherein the weight per surface area of the knitted fabric (2) is less than 21 g/m² and preferably amounts to between 10 and 18 g/m².

8. Laminate material element according to claim 1, wherein the carrier (1) is a film.

9. Laminate material element according to claim 1, wherein the carrier (1) and the knitted fabric (2) are glued to one another over their full area in an edge region that extends along the edges of the laminate material element and has the shape of a frame (8).
